(19) United States
(12) Patent Application Publication
(10) Pub. No.: US 2021/0225342 A1
(43) Pub. Date: Jul. 22, 2021

(54) PROTECTIVE COVER FOR ELECTRONIC MUSIC EQUIPMENT

(71) Applicant: Aaron Thomas, Southgate, KY (US)

(72) Inventor: Aaron Thomas, Southgate, KY (US)

(21) Appl. No.: 17/151,003

(22) Filed: Jan. 15, 2021

Related U.S. Application Data
(60) Provisional application No. 62/962,507, filed on Jan. 17, 2020.

(51) Int. Cl. G10H 1/32; G10H 1/00

(52) U.S. Cl. CPC G10H 1/32; G10H 1/0008

(57) ABSTRACT

A protective cover for electronic music equipment, wherein the protective cover provides protection from liquid spills and from the elements (for example, dust, smoke, and rain) while still allowing for full functionality of the electronic music equipment.

### BACKGROUND OF THE INVENTION

### 1. Field of the Invention

The disclosed invention relates to protective covers for electronic music equipment such as electronic devices and electronic accessories.

### 2. Description of the Related Art

Electronic musical equipment, such as guitar devices and accessories like amps, modelers, and pedals are often expensive, delicate, and vulnerable to damage from liquids (e.g., water, a spilled beverage) as well as certain environmental impacts (e.g., dust, smoke, rain). Over the last ten to fifteen years, it has become even more important to protect electronic music equipment as it has become more sophisticated and expensive. A single piece of electronic music equipment can be very expensive, so there is a need to protect it.

For example, an electric guitarist or bassist's equipment setup would traditionally involve an amplification unit (combo amp or amp head and speaker cabinet), various sound effects pedals (traditional stompboxes or controllers for rack mounted units), then microphones and cables to carry the signal to a PA system. Recent developments in technology have enabled all the elements of a traditional equipment setup to be synthesized into one unit capable of taking the place of all the individual elements, providing greater ease in setup, transportability, and sound reinforcement capability. With all elements being combined into a single unit, the possibilities of jeopardizing a performance become greater, however, should the unit fail or be compromised somehow during a performance situation. With a traditional setup, a performer could eliminate one or more of the elements to continue a performance should something occur with one of the parts of the setup (i.e., if his stompboxes fail, he can plug straight into an amplifier to continue performing.). If a performer chooses to utilize this newer all-in-one technology, and if the unit becomes compromised or fails, the options to continue the performance are severely limited, as there are no additional components of the equipment setup to fall back on.

Music equipment owners go to great lengths to try to protect their equipment. There exist protective articles such as dust covers, polycarbonate covers, padded covers, soft cases, and the like. However, these article are designed to protect equipment when it is not in use or when it is being transported. They do not allow for the equipment to be both protected and used at the same time.

Along with protecting from catastrophic damage, a protective cover is needed which protects equipment from day-to-day, wear-and-tear damage. In the music industry, there is a huge used-equipment market, and the cosmetic condition of equipment is a big factor in resale pricing. There is a need to protect equipment's cosmetic appearance for resale value in the used market.

Currently available protective articles which are designed to allow some use of the equipment are too rigid (i.e., not flexible enough) to allow full functionality of the electronic music device. For example, it can be hard or impossible to turn knobs, press buttons, adjust volume or parameters, or engage foot switches on equipment when a polycarbonate/hard plastic protective cover is present. Hard plastic covers exist which protect only a portion of a piece of equipment, but they do not protect against much. Musicians have been known to use plastic bags and plastic cling wrap to cover their electronic devices. Accordingly, there is a need for a cover which fully protects electronic music equipment from damage due to spills and the elements without interfering with the functionality of the equipment. There is a need for a protective cover that musicians won't mind using all the time to protect from wear-and-tear and cosmetic damage.

### SUMMARY OF THE INVENTION

Disclosed herein is a protective cover for electronic music equipment, wherein the electronic music equipment comprises controls and a surface profile, wherein the cover comprises a surface profile, and wherein the surface profile of the cover corresponds precisely with the surface profile of the electronic music equipment. The protective cover may allow for full functionality of the electronic music equipment. The protective cover may be made of a water-resistant and/or durable material. The protective cover may be removable, flexible, and/or transparent. The protective cover may comprise one or more openings sized to allow the controls to pass through. The protective cover may comprise one or more collars or access areas to protect the controls.

### BRIEF DESCRIPTION OF THE FIGURES

The drawings and detailed description that follow are intended to be merely illustrative and are not intended to limit the scope of the invention as contemplated by the inventors. The detailed description of specific embodiments of the present invention can be best understood when read in conjunction with the following drawings.

FIG. 1 is a side view of a first embodiment of a protective cover.

FIG. 2 is a top view of the protective cover of FIG. 1.

FIG. 3 is a front view of the protective cover of FIG. 1.

FIG. 4 is a cross-sectional view of the midpoint of the protective cover of FIG. 1.

FIG. 5 is a perspective view of a second embodiment of a protective cover.

FIG. 6 is a top view of the protective cover of FIG. 5.

FIG. 7 is a side view of the protective cover of FIG. 5.

### DETAILED DESCRIPTION OF THE INVENTION

The inventor conceived of a novel protective cover that, for the purpose of illustration, is disclosed herein as applied in the context of electronic music equipment. While the disclosed applications of the inventor's protective cover satisfy a long-felt but unmet need in the art of electronic music equipment, it should be understood that the inventor's protective cover is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

The present invention comprises a protective cover for electronic music equipment that provides protection from liquid spills and from the elements (for example, dust, smoke, and rain). More specifically, the protective cover may cover electronic music equipment such as the modeler/foot pedal/foot controller segment of the amplification/effects processor segment of music-industry-related markets. A “pedal” could be thought of as a single switch, where a “foot controller” or “MIDI foot controllers” can have multiple switches or buttons. There are also Bluetooth controllers that serve a similar function (floor units/controllers with multiple switches/buttons). The present invention is especially suitable for the aforementioned equipment. Outside of that segment, the protective cover may be valuable in live music production (current iterations of digital DJ equipment including mixers and production/sampling units and workstations, as well as sound/mixing consoles).

The protective cover generally sits on top of a piece of music equipment. The cover is preferably removable, but it may also be permanent. The protective cover may completely or partially cover the top surface, the right-side surface, left-side surface, front surface, back surface, and/or bottom surface. In a preferred embodiment, the protective cover completely covers the top surface and completely or almost completely covers the four sides' surfaces. For music equipment which is not generally in the form of a six-sided cube or rectangular prism, the protective cover may be designed to cover all areas which are vulnerable to damage. Along with protecting from catastrophic damage, the protective cover is also beneficial to protect the equipment's cosmetic appearance for resale value in the used market. In the music industry, there is a huge used-equipment market, and the cosmetic condition of equipment is a big factor in resale pricing.

Because the protective cover must also be functional, and not inhibit use of the music equipment, the cover is in the form of a flexible form-fitting sheath with protrusions and/or access areas to accommodate the device controls. These protrusions extend above the surface of the cover and have openings which align with knobs, dials, switches, and other controls present on the surface of the music equipment. In a preferred embodiment, the protrusion height is about 0.125 in (3.175 mm). The music equipment controls may extend up through the openings in the cover such that they may be maneuvered on a plane higher than the plane of the top of the protrusion. Access areas are generally lower profile than protrusions but higher profile than the surface of the cover. In access areas, the cover may be molded to mirror the shape of buttons or other controls to enable the music equipment controls to be maneuvered while they are fully protected under the cover. The display panel viewing area may be recessed, or a lower profile than the surrounding cover surface. The cover must be sized precisely to ensure that it is snug around the music equipment controls but not interfering with the controls—for instance, it is not desirable for a collar to make it difficult to turn a control knob or footswitch. Likewise, it is not desirable for an access area to constantly depress buttons.

The protective cover may comprise different material thicknesses in different regions. For instance, the access areas of the cover, which provide the ability to see a device display panel or manipulate a button or control, are preferably a thinner thickness than the surrounding cover thickness. Thinner material enables the user to better see and better control the equipment. Varying thicknesses may make the cover easier and/or cheaper to manufacture, easier to install and remove on the music equipment, or make the access areas less noticeable. Certain parts of the cover may benefit from having better durability provided by thicker material. In a preferred embodiment, the sides, front, and back awnings are about 0.06 in (1.524 mm) thick, the top is about 0.04 in (1.016 mm) thick, and the button access areas and display panel viewing area are about 0.03in (0.762 mm) thick.

The protective cover is preferably durable and able to easily be cleaned and reused many times. Yet, in some instances, there may be a desire to have a disposable protective cover. For instance, if music equipment will be in a particularly dusty, muddy, otherwise dangerous environment, it might be desired to use a protective cover and dispose of the protective cover after use.

In a preferred embodiment, the protective cover is molded from an elastomer, such as polyurethane elastomer, which is flexible. In other embodiments, the cover may be made from silicone or other flexible material. The tensile elongation of the material may be above 200%, or above 250%, or about 300%. In a preferred embodiment, the elongation is about 300%. The Shore A hardness of the material may be less than about 70, or less than about 60, or less than about 50. In a preferred embodiment, the Shore A hardness is about 45. The protective covers may be customizable from a color standpoint. The material may be clear or it may be tinted or pigmented to provide a cover having one or more colors. In one embodiment, the top surface is clear while the sides are tinted (and possibly even opaque). For example, the sides could be a color to match a band's brand (e.g., electric blue), thereby deterring theft and adding to the band's ambiance. Or, the entire cover may be transparent yet tinted one or more colors. The material may be UV-light and oxidation resistant.

Preferably, the protective cover is made from a transparent flexible material that enables any labels or printing on the music equipment near the controls to be easily viewed while the cover is in place on the equipment. In other embodiments, depending on the music equipment, it may make more sense and be more cost effective for the protective cover to be translucent, semitransparent, or opaque in some or all parts of the cover. The cover may have words (or numbers or characters) on it which correspond to the controls beneath.

To enable this protective cover to be customized for various different types of music equipment, it is desirable to design the cover using computer-aided design (“CAD”). CAD-designing the protective covers allows for custom-made covers fitted for a variety of specific types and models of electronic devices to allow full functionality while still providing protection.

In order to protect a piece of electronic music equipment, the user places the protective cover onto the electronic device so that the collar openings on the cover line up with the controls (knobs, dials, switches, etc.) on the device such that the controls extend up through the collar. If necessary, the user may shift the cover to ensure that the access areas are properly lined up with the buttons underneath and to ensure that the collars are positioned correctly so they do not interfere with movement of the controls.

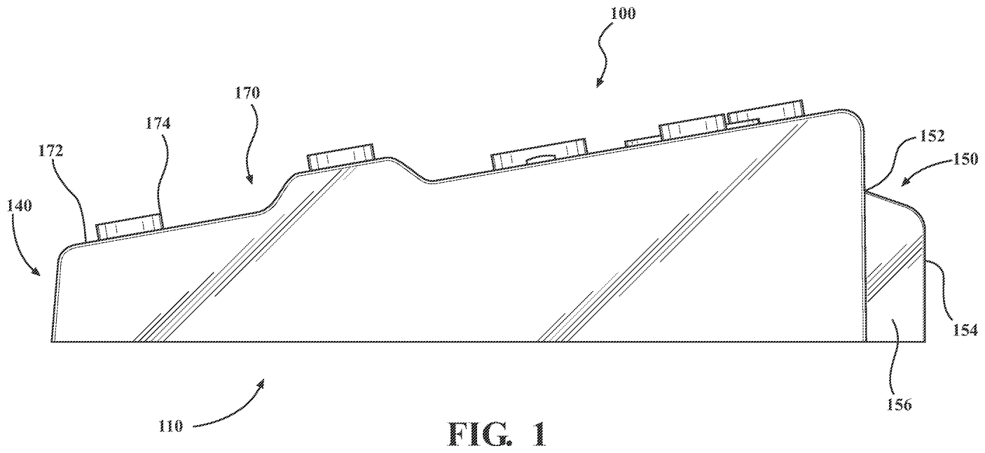

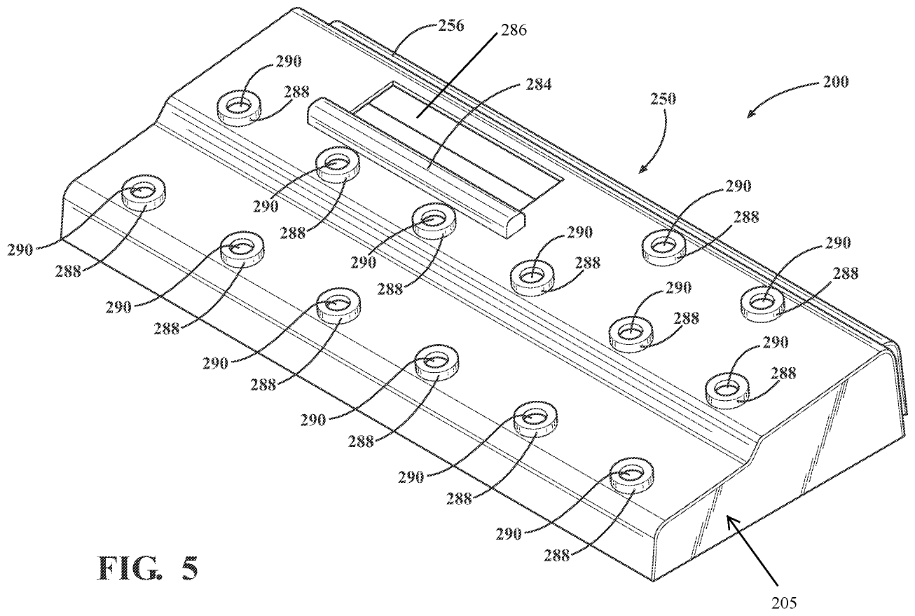

Referring now to the figures, FIGS. 1-4 show a first embodiment of a protective cover. FIGS. 5-7 show a second embodiment of a smaller, less intricate protective cover.

FIG. 1 is a side view of a first embodiment of a protective cover 100 designed for a piece of music equipment known as a guitar modeler, or foot pedal/foot controller. The cover 100 comprises an internal cavity 105 wherein the music equipment resides. The cover 100 has a bottom 110, a right side 120, left side 130, front 140, back 150, and top 170. The top 170 of the cover 100 comprises one or more protrusions and access areas on the cover surface 172. These protrusions extend above the surface of the cover 172 to a height 174 and align with buttons, knobs, and switches present on the surface of the modeler. The back 150 of the cover 100 comprises two awnings 154, 162. The first awning 154 may be flexed or folded upwards along a crease 152 to enable access to the modeler's power port and input/output jacks. The crease 152 may be in the form of a living hinge.

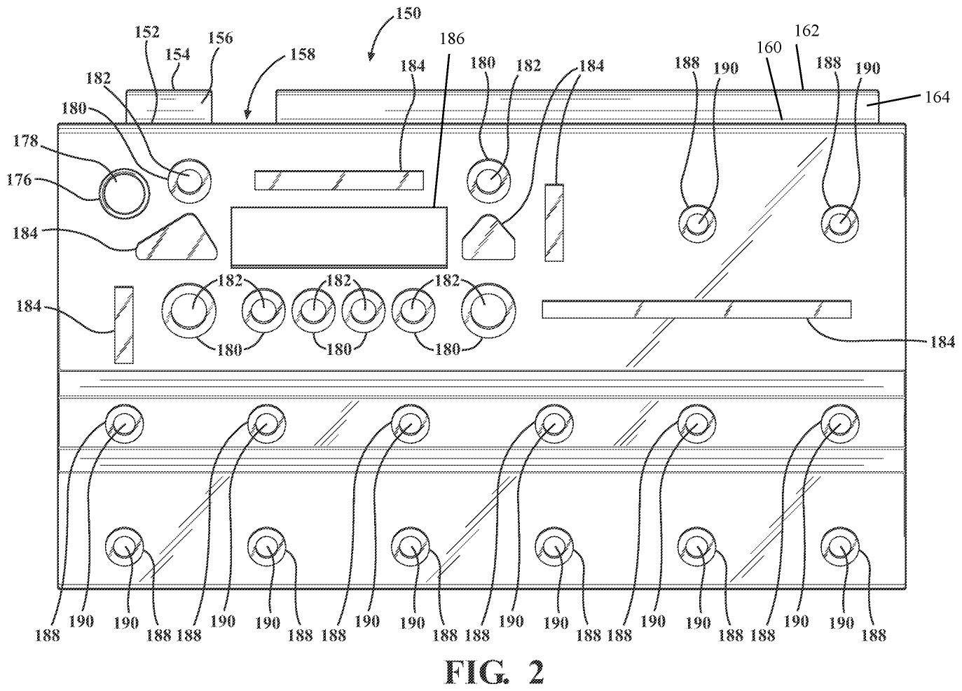

FIG. 2 is a top view of the protective cover 100. The cover 100 surface 172 comprises a variety of different features. From this top view, it is apparent that the cover comprises two awnings 154, 162 each comprising a crease 152, 160 and a protected space 156, 164. The first awning 154 covers the modeler's IEC/power cable. The second awning 162 covers the modeler's connections panel. The modeler may comprise ¼ inch instrument cable inputs and outputs, TRS (balanced ¼ inch cable) inputs, XLR (3 pin) cable inputs and outputs, and USB and S/PDIF inputs and outputs, CAT5 or CAT6 inputs, and/or MIDI cable (5- or 7-pin) inputs and outputs. The awnings may be sized to properly cover and protect these cables and jacks.

FIG. 2 also illustrates the various protrusions 174 and access areas 192 present on the cover surface 172. The protrusions and access areas may have different shapes, dimensions, open areas, and heights depending on the control features present on the music equipment. Here, a power button access area 176 covers the modeler's power button yet still allows for easy operation of the power button via a thinner cover thickness 178. Control knob collars 180 provide access to the modeler's control knobs via openings 182 in the cover 100 to enable a user to twist the knobs. Function button access areas 184 cover the modeler's function buttons yet still enable a user to press the buttons. These areas 184 are thinner and/or raised elements on the protective cover 100. A display panel viewing area 186 is sized to accommodate the modeler's display panel and enable a user to read the display panel. The display panel viewing area 186 may be slightly recessed to enable the best viewing of the device's display. The display panel viewing area 186 may comprise a thinner cover 100 thickness such that the modeler display is more easily viewable through the cover 100. Footswitch collars 188 provide access to the modeler's footswitches via openings 190 in the cover 100 to enable a user to engage the footswitches.

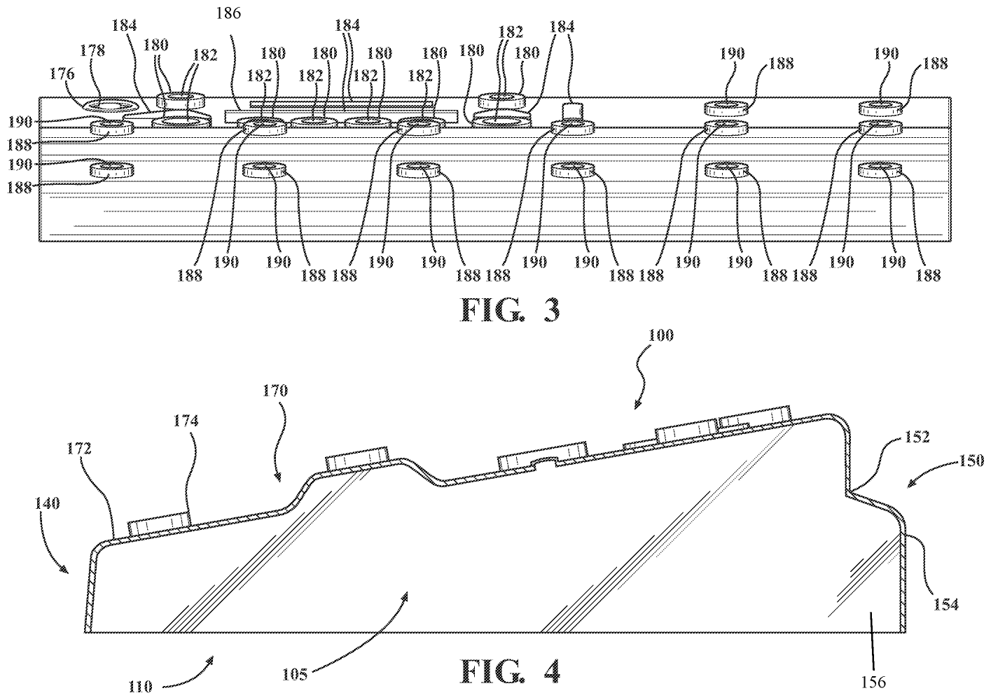

FIG. 3 is a front view of the protective cover 100 and illustrates the heights of the control knob collars 180 and footswitch collars 188. FIG. 4 is a cross-sectional view of the protective cover 100 and illustrates the cavity 105 which is sized to fit a modeler.

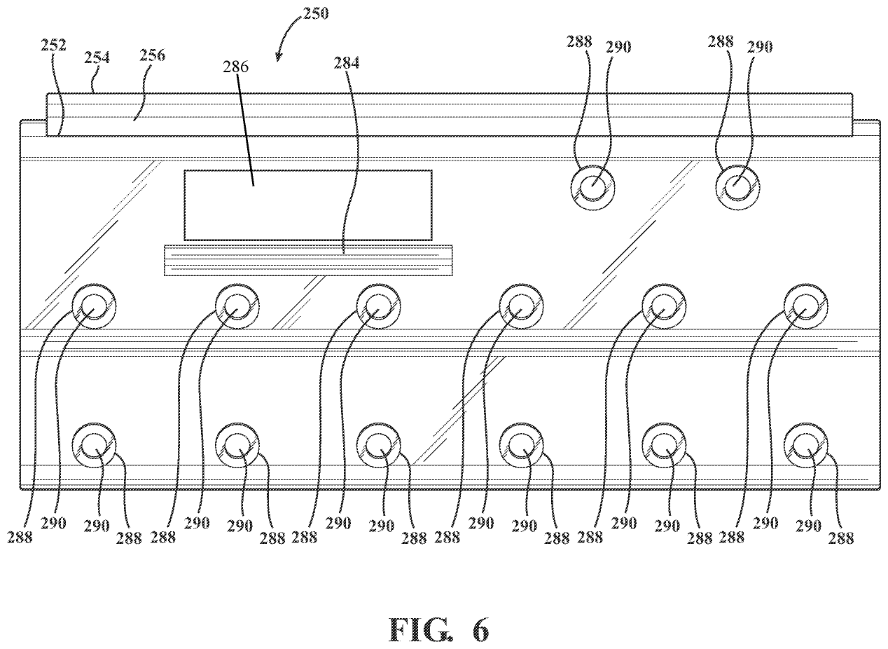

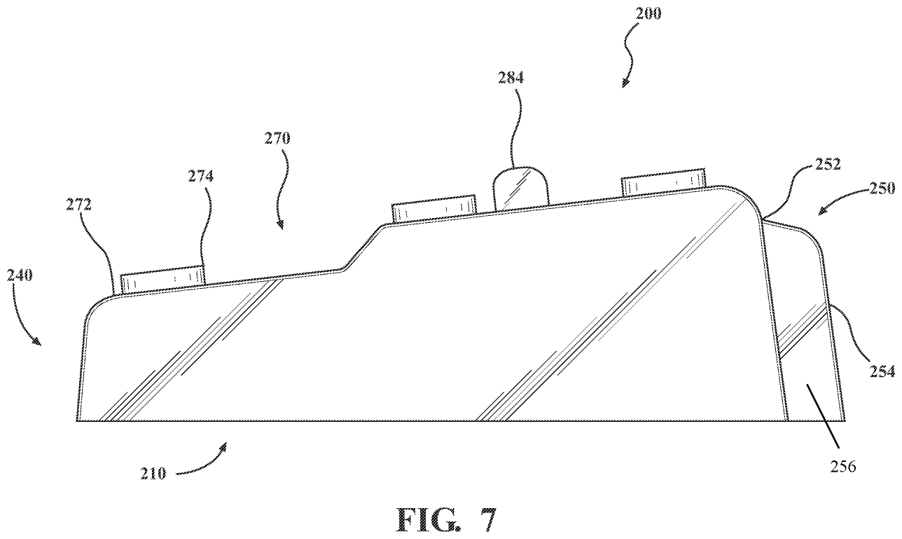

FIG. 5 is a perspective view, FIG. 6 is a top view, and FIG. 7 is a side view of a second embodiment of a protective cover 200 designed for a smaller guitar modeler. The cover 200 comprises an internal cavity 205 wherein the music equipment resides. The cover 200 has a bottom 210, a right side 220, left side 230, front 240, back 250, and top 270. The top 270 of the cover 200 comprises one or more protrusions and access areas on the cover surface 272. These protrusions extend above the surface of the cover 272 to a height 274 and align with buttons, knobs, and switches present on the surface of the modeler. The back 250 of the cover 200 comprises one awning 254. The awning 254 may be flexed or folded upwards along a crease 252 to enable access to the modeler's power port and input/output jacks. The crease 252 may be in the form of a living hinge. The awning 254 creates a protected space 256 for connected cables/jacks.

FIGS. 5-7 also illustrate various protrusions and access areas present on the cover surface 272. The protrusions and access areas may have different shapes, dimensions, open areas, and heights depending on the control features present on the music equipment. A footguard access area 284 provides a cover for the modeler's footguard (a raised piece of metal intended to prevent stepping on the display) to enable a user to press the buttons. A display panel viewing area 286 is sized to accommodate the modeler's display panel and enable a user to read the display panel. The display panel viewing area 286 may be slightly recessed to enable the best viewing of the device's display. The display panel viewing area 286 may comprise a thinner cover 200 thickness such that the modeler display is more easily viewable through the cover 200. Footswitch collars 288 provide access to the modeler's footswitches via openings 290 in the cover 200 to enable a user to engage the footswitches.

As one of ordinary skill in the art will appreciate, the protective cover of the present invention may be modified to be used for a variety of other musical instrument devices and accessories. It would be especially useful for music equipment used at concerts, bars, weddings, outdoor performance locations where environmental hazards may occur (e.g., rain), or other venues where there is a chance a beverage could be spilled on the equipment. For instance, a protective cover could be customized for karaoke equipment; speakers; PA systems; power sources; lighting; keyboards; amps; pedals; DJ equipment such as controllers, interfaces, turntables, mixers; and more.

While specific embodiments of the inventor's novel invention were illustrated and described herein, variations and modifications may be made by those skilled in the art without departing from the scope of this disclosure. The present disclosure is for purposes of illustration and not of limitation; it may take many forms other than those explicitly disclosed herein. As such, the claims below shall be read to include all obvious variations and modifications that may be within the spirit of this invention.

What is claimed is:

1. A protective cover for electronic music equipment, wherein the electronic music equipment comprises controls and a surface profile, wherein the cover comprises a surface profile, and wherein the surface profile of the cover corresponds precisely with the surface profile of the electronic music equipment.

2. The protective cover of claim 1, wherein the cover allows for full functionality of the electronic music equipment.

3. The protective cover of claim 1, wherein the cover is made of a water-resistant material.

4. The protective cover of claim 1, wherein the cover is removable.

5. The protective cover of claim 1, wherein the cover is flexible.

6. The protective cover of claim 1, wherein the cover is transparent.

7. The protective cover of claim 1, wherein the cover comprises one or more openings sized to allow the controls to pass through.

8. The protective cover of claim 1, wherein the cover comprises one or more collars or access areas to protect the controls.

9. A protective cover for electronic music equipment having controls, wherein the cover comprises a transparent, flexible, water-resistant, and durable material.

10. The protective cover of claim 8, wherein the cover allows for full functionality of the electronic music equipment.

11. The protective cover of claim 8, wherein the cover is removable.

12. The protective cover of claim 8, wherein the cover comprises one or more openings sized to allow the controls to pass through.

13. The protective cover of claim 8, wherein the cover comprises one or more collars or access areas to protect the controls.

14. A protective cover for electronic music equipment, wherein the electronic music equipment comprises controls and a surface profile, wherein the cover comprises a surface profile, and wherein the surface profile of the cover corresponds precisely with the surface profile of the electronic music equipment such that the cover allows for full functionality of the electronic music equipment while the cover is positioned on the electronic music equipment.

15. The protective cover of claim 14, wherein the cover is made of a water-resistant material.

16. The protective cover of claim 14, wherein the cover is removable.

17. The protective cover of claim 14, wherein the cover is flexible.

18. The protective cover of claim 14, wherein the cover is transparent.

19. The protective cover of claim 14, wherein the cover comprises one or more openings sized to allow the controls to pass through.

20. The protective cover of claim 14, wherein the cover comprises one or more collars or access areas to protect the controls.
